(19) United States
(12) Patent Application Publication
(10) Pub. No.: US 2019/0377921 A1
(43) Pub. Date: Dec. 12, 2019

(54) FINGERPRINT IDENTIFICATION SYSTEM AND FINGERPRINT IDENTIFICATION METHOD

(71) Applicant: HIMAX TECHNOLOGIES LIMITED, Tainan City (TW)

(72) Inventor: Tsung-Yau Huang, Tainan City (TW)

(21) Appl. No.: 16/003,096

(22) Filed: Jun. 7, 2018

(51) Int. Cl. G06K 9/00

(52) U.S. Cl. CPC G06K 9/001; G06K 9/00013

(57) ABSTRACT

Disclosed is a fingerprint identification system comprising an image acquiring device and a processing circuit. The image acquiring device acquires at least one second image. The processing circuit performs following steps: (a) selecting a plurality of first align points from first ridge points of a first image, and selecting a plurality of second align points from second ridge points of the second image; (b) pairing at least one of the second align points to at least one first paired align point among the first align points; (c) calculating at least one transform function based on the second align point and the first paired align point; and (d) transforming the second image to a second transformed image according to the transform function, and determining if the second image matches any part of the first image according to the second transformed image and at least part of the first image.

### BACKGROUND OF THE INVENTION

### 1. Field of the Invention

The present invention relates to a fingerprint identification system and a fingerprint identification method, and particularly relates to a fingerprint identification system and a fingerprint identification method which can decrease calculation amount.

### 2. Description of the Prior Art

A conventional fingerprint identification method compares an image to be identified (e.g. an image for a user's fingerprint) with a reference image of a recorded fingerprint to identify whether the user's fingerprint matches the recorded fingerprint or not.

However, the conventional fingerprint identification method must compares a whole image of the image to be identified with a whole image of the reference image, thus the calculation amount is large and needs a lot of time to identify the fingerprint.

### SUMMARY OF THE INVENTION

Therefore, one objective of the present invention is to provide a fingerprint identification system which can reduce calculation amount.

Another objective of the present invention is to provide a fingerprint identification method which can reduce calculation amount.

One embodiment of the present invention provides a fingerprint identification system comprising an image acquiring device and a processing circuit. The image acquiring device is configured to acquire at least one second image. The processing circuit is configured to perform following steps: (a) selecting a plurality of first align points from first ridge points of a first image, and selecting a plurality of second align points from second ridge points of the second image; (b) pairing at least one of the second align points to at least one first paired align point among the first align points; (c) calculating at least one transform function based on the second align point and the first paired align point; and (d) transforming the second image to a second transformed image according to the transform function, and determining if the second image matches any part of the first image according to the second transformed image and at least part of the first image.

Another embodiment of the present invention provides a fingerprint identification method, which is applied to a fingerprint identification system comprising an image acquiring device and a processing circuit. The steps of the fingerprint identification method can be acquired based on above-mentioned embodiments, thus are omitted for brevity here.

Based upon above-mentioned embodiments, only partial of the second image is compared with the first image, thus the calculation amount for identifying fingerprint can be greatly reduced and the speed of identifying fingerprint raises up.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a fingerprint identification system according to one embodiment of the present invention.

FIG. 2 is a schematic diagram illustrating an example that a fingerprint sensing surface is located in a notebook.

FIG. 3 is a flow chart illustrating the steps for a fingerprint identification method according to one embodiment of the present application.

FIG. 4-FIG. 6 are exemplary schematic diagrams illustrating the operations for the steps illustrated in FIG. 3.

FIG. 7 is an exemplary schematic diagram illustrating the iteratively refine operation according to one embodiment of the present invention.

### DETAILED DESCRIPTION

Several embodiments are provided in following descriptions to explain the concept of the present application. Please note, the components in each embodiment can be implemented by hardware (e.g. circuit or apparatus) or by hardware with software (e.g. a processor installed with at least one program). Additionally, the components in each embodiment can be separated to more components or be integrated to fewer components. Besides, the steps illustrated in following embodiments can be separated into more steps or integrated into fewer steps. Such variation should fall in the scope of the present application. Additionally, in following embodiments, the terms “first”, “second”, “third” . . . is only for defining different components and do not mean the order thereof. For example, the “first image” and the “second image” only mean the images are different ones, and do not mean that the “second image” must be generated or be transmitted after the “first image”.

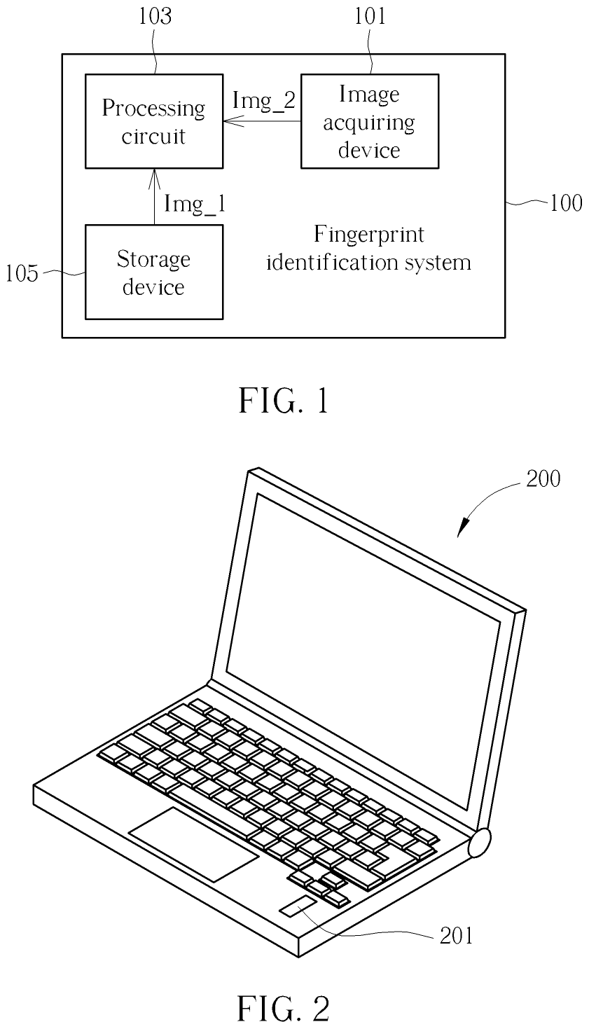

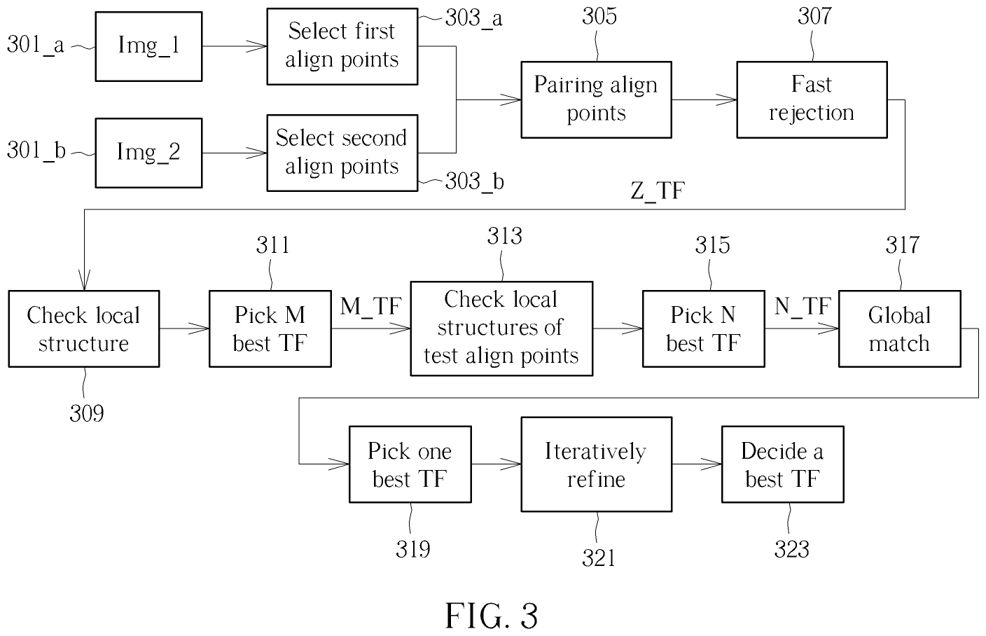

FIG. 1 is a block diagram illustrating a fingerprint identification system 100 according to one embodiment of the present invention. As illustrated in FIG. 1, the fingerprint identification system 100 comprises an image acquiring device 101, a processing circuit 103 and a storage device 105. The image acquiring device 101 is configured to acquire at least one second image Img_2, which can be an image to be identified (e.g. a user's fingerprint image). The image acquiring device 101 can have a finger sensing surface provided on an electronic apparatus such as a mobile phone or a notebook. For example, as illustrated in FIG. 2, the image acquiring device 101 has a fingerprint sensing surface 201 provided on a notebook or other portable device such as smartphone or tablet PC. A user can put his finger on this fingerprint sensing surface 201, thereby the image acquiring device 101 can acquire the user's fingerprint image. The image acquiring device 101 can be an optical image acquiring device or a capacitive image acquiring device, or any other kind of image acquiring device.

The processing circuit 103 is configured to select a plurality of first align points from first ridge points of a first image Img_1, and selecting a plurality of second align points from second ridge points of the second image Img_2. In following embodiments, the first image Img_1 is a reference image, which can be recorded in a storage device 105. Please note the storage device 105 can be located in any other place rather than located in the fingerprint identification system 100. Also, as above-mentioned, the second image Img_2 can be an image to be identified. However, the first image Img_1 and the second image Img_2 are not limited to above-mentioned embodiments.

Additionally, the processing circuit 103 is configured to pair at least one of the second align points to at least one first paired align point among the first align points, calculates at least one transform function based on the second align point and the first paired align point. These steps will be described for more details later. After that, the processing circuit 103 transforms the second image Img_2 to a second transformed image and determines if the second image Img_2 matches any part of the first image Img_1 via comparing the second transformed image and at least part of the first image Img_1.

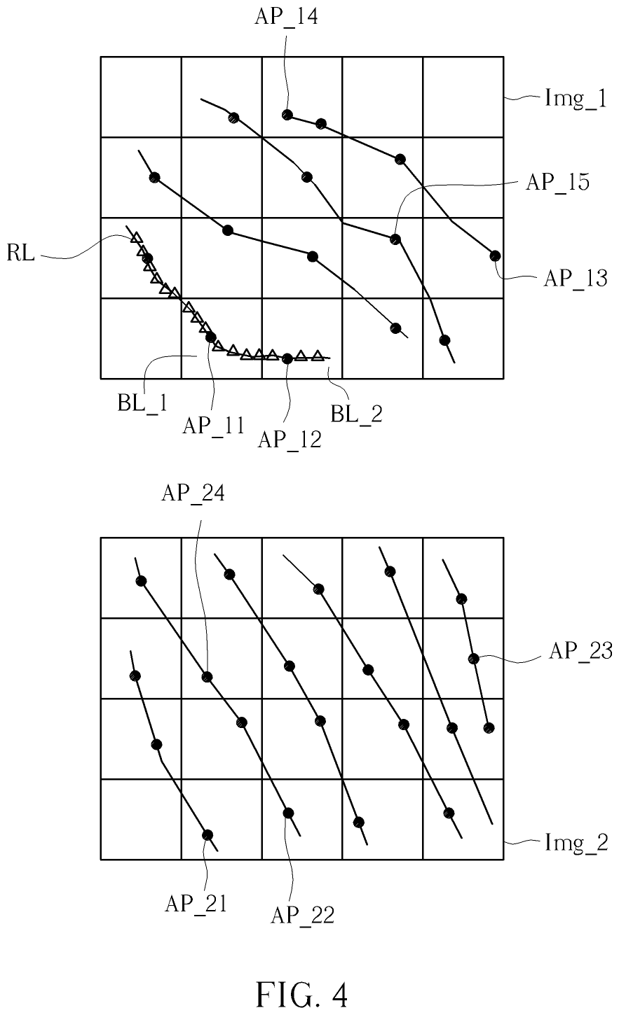

FIG. 3 is a flow chart illustrating detail steps for a fingerprint identification method, according to one embodiment of the present application. Please refer to FIG. 1 in conjunction with FIG. 3 to understand the concept of the present invention for more clear.

The flow chart in FIG. 3 comprises following steps:

Step 301_a

Acquire at least one first image Img_1. For example, read the first image Img_1 from the storage device 105 illustrated in FIG. 1.

Step 301_b

Acquire at least one second image Img_2. For example, apply the image acquiring device 101 in FIG. 1 to acquire the second image Img_2.

Please note, the first image Img_1 and the second image Img_2 can be original images (i.e. the imaged sensed by the image acquiring device) or images enhanced from original images, such as skeleton ridge images. In following embodiments, the first image Img_1 and the second image Img_2 are skeleton ridge images.

Step 303_a

Select a plurality of first align points from first ridge points of a first image Img_1

Step 303_b

Select a plurality of second align points from second ridge points of the second image Img_2.

Step 305

Pair at least one of the second align points to at least one first paired align point among the first align points. Also, the step 305 calculates transform functions for at least one combination of the second align point and the first paired align point.

Step 307

Perform fast rejection to the transform functions calculated from the step 305. It is supposed that Z transform functions (Z_TF in FIG. 3) are retained after the fast rejection.

Step 309

Check local structures of at least one second ridge point in the second image Img_2, via applying least one of the Z transform functions.

Step 311

Select M transform functions according to results of the step 309.

Step 313

Check local structures of at least one test align point in the second image Img_2, via applying at least one of the M transform functions.

Step 315

Select N transform functions according to results of the step 313.

Step 317

Check matching levels of all ridge points for the N transform functions.

Step 319

Select one best transform function based on the result of the step 317.

In one embodiment, the best transform function found in the step 319 is applied as the final transform function, which is applied to transform the second image Img_2 to the transformed second image for comparing.

Step 321

Iteratively refine the transform function. Briefly, such step iteratively calculates the average match level between the transformed second image and the first image Img_1 and refines the transform function based on the average match level.

Step 323

Select the transform function acquired in the step 321 as the final transform function, which is applied to transform the second image Img_2 to the transformed second image for comparing.

In one embodiment, the steps 321 and 323 are omitted.

The steps 307-323 can be regarded as: Calculate at least one transform function based on the second align point and the first paired align point. Therefore, it will be appreciated that the steps 307-323 are not limited to be combined together. The fingerprint identification method provided by the present invention can comprise only a part of the steps 307-323. For example, the flow chart in FIG. 3 can only comprise the steps 301a-307, such that the second image Img_2 is transformed based on the transform function retained in the step 307. For another example, the flow chart in FIG. 3 can only comprise the steps 301a-305, and steps 309-311, such that the second image Img_2 is transformed based on the transform function retained in the step 311. Such variation should also fall in the scope of the present invention.

The details for the steps in FIG. 3 are illustrated in following drawing. Please note the following drawings are only examples for explaining steps in FIG. 3, but do not mean to limit the scope of the present invention.

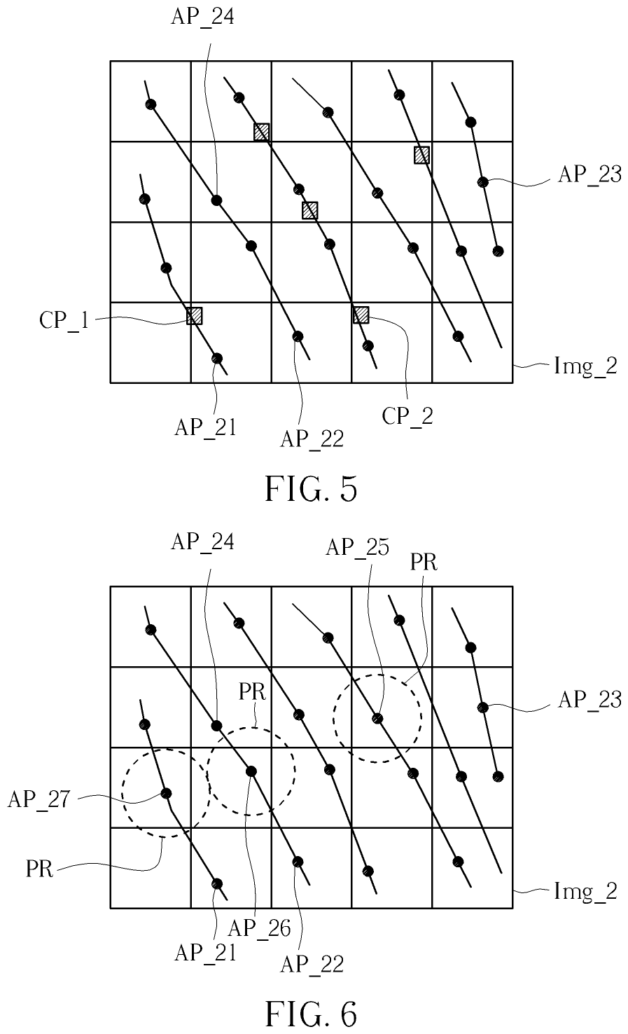

FIG. 4 is an exemplary schematic diagram illustrating the steps 303a, 303b and 305 in FIG. 3. Please note, for the clarity of drawings, only some of the ridge lines, the ridge points and the align points are symbolized or marked in FIG. 4. As illustrated in FIG. 4, a plurality of first align points AP_11 . . . AP_15 are selected from the first ridge points, which are marked by triangles in the ridge line RL_1. The ridge line RL can mean the dark part (i.e. wave trough) or the bright part (i.e. wave crest) of a fingerprint image. Also, the first ridge points mean the pixel points in the ridge line of the first image Img_1. Some of the first ridge points are selected as the first align points. Following the same rule, the second align points AP_21-AP_24 are selected from the second ridge points of the second image Img_2.

In one embodiments, the first ridge points are downsampled to acquire the first align points. For example, the first image Img_1 can have a plurality of image blocks BL_1, BL_2. Each of the image blocks BL_1, BL_2 comprises a plurality of first ride points. However, only one first ridge point is selected as the first align point AP_11 in the image block BL_1. Similarly, only one first ridge point is selected as the first align point AP_12 in the image block BL_2. The second align point AP_21 and AP_22 are selected following the same way. The downsample rates for the first image Img_1 and for the second image Img_2 can be the same or different.

Next, after the first align points and the second align points are selected. Each of the second align points is paired to one of the first align points. For example, the second align point AP_21 is paired to the first align point AP_11, and the second align point AP_22 is paired to the first align point AP_12. For the convenience of explaining, in following embodiments, the first align point paired to the second align point is named as a first paired align point. In above-mentioned examples, the first align point AP_11 is a first paired align point of the second align point AP_21. Please note, a second align point can have more than one first paired align point.

After the first align points and the second align points are paired, the transform functions for each of the second align points and the first paired align points thereof are calculated. The transform function can indicate the angle between a tangent line of the second align point and a tangent line of the first paired align point. Also, transform function can further indicate the displacement between the second align point and the first paired align point. In one example, the transform function can be shown as Equation (1):

$$[ \begin{matrix}X 1 \\ Y 1\end{matrix} ] = [ \begin{matrix}cos θ & - sin θ \\ sin θ & cos θ\end{matrix} ] [ \begin{matrix}X 2 \\ Y 2\end{matrix} ] + [ \begin{matrix}tx \\ ty\end{matrix} ] \\ [ \begin{matrix}X 1 \\ Y 1\end{matrix} ] and [ \begin{matrix}X 2 \\ Y 2\end{matrix} ] \qquad Equation ( 1 )$$

respectively mean the coordinates for the first paired align point and the second align point. The θ means the angle between the tangent line of the second align point and the tangent line of the first paired align point, and the matrix

$$[ \begin{matrix}tx \\ ty\end{matrix} ]$$

indicates the displacement between the second align point and the first paired align point. Therefore, the matrix

$$[ \begin{matrix}cos θ & - sin θ \\ sin θ & cos θ\end{matrix} ]$$

and the matrix

$$[ \begin{matrix}tx \\ ty\end{matrix} ]$$

can indicate the transform function. Please note the θ can be replaced by 180°+θ, since the tangent line can rotate in another direction. Therefore, if P first align points and Q second align points are selected in the steps 303_a and 303_b, a maximum number of P*Q*2 transform functions can be acquired.

In the step 307, fast rejection is performed to the transform functions calculated from the step 305. In one embodiment, the transform function is abandoned, if a number for the second ridge points in a predetermined region of the second align point or a number for the first ridge points in the predetermined region of the first paired align point is smaller than a predetermined number. Take FIG. 4 for example, a number for the first ridge points in the predetermined region of the first align point AP_13 is small, and a number for the second ridge points in the predetermined region of the second paired align point AP_23 is large, thus the transform functions for the first paired align point AP_13 and the second paired align point AP_23 are abandoned. Please note, such step can be performed in the step 305. That is, since a number for the first ridge points in the predetermined region of the first paired align point AP_13 is small and a number for the second ridge points in the predetermined region of the second paired align point AP_23 is large, the transform function for the first align point AP_13 and the second paired align point AP_23 is not calculated in the step 305.

In one embodiment, in the step 307, the transform function is abandoned if a difference between a number for the second ridge points in a predetermined region of the second align point and a number for the first ridge points in the predetermined region of the first paired align point is larger than a predetermined number. Take FIG. 3 for example, a number for first ridge points in a predetermined range of the first align point AP_14 is small but a number for second ridge points in a predetermined range of the second align point AP_24 is large, thus the transform function for the first align point AP_14 and the second align point AP_24 is abandoned. Please note, such step can be performed in the step 305. That is, since a number for first ridge points in a predetermined range of the first align point AP_14 is small but a number for second ridge points in a predetermined range of the second align point AP_24 is large, the transform functions for the first align point AP_14 and the second paired align point AP_24 is not calculated in the step 305.

In one embodiment, in the step 307, at least one check point from the second ridge points is selected, then the transform functions acquired in the step 305 are applied to transform the check point to a transformed check point. Next, compare the transformed check point to the first ridge points.

Afterwards, angles of the check points (i.e. the angle of tangent lines) and angles of the transformed checkpoint are compared, and the transform function is abandoned if matching levels between angles of the transformed check points and angles of the first ridge points are smaller than predetermined levels.

For example, as illustrated in FIG. 5, a plurality of check points CP_1, CP_2 are selected for the second image Img_2 (only two of them are symbolized). A transform function T1 among the transform functions acquired in the step 305 is applied to transform these check points to transformed check points. After that, angles of the check points (i.e. the angle of tangent lines) and angles of the transformed check point are compared, and the transform function T1 is abandoned if matching levels between angles of the transformed check points and angles of the first ridge points are smaller than predetermined levels.

Please note, the step 307 can comprise only partial steps of above-mentioned steps, and all or partial transform functions can be checked by the step 307. In one embodiment, it is supposed Z transform functions are retained (e.g. not abandoned after the step 305).

FIG. 6 is an exemplary schematic diagram for the steps 309, 311 in FIG. 1. In FIG. 6, a test align point among the second align points is selected, and the transform function for the test align point and the first paired align point corresponding to the test align point is applied to transform the second ridge points in a predetermined range of the test align point to second transformed ridge points. For example, as illustrated in FIG. 6, the second align point AP_25 in FIG. 6 is selected as the test align point, and the first paired align point corresponding to the second align point AP_25 is the first align point AP_15 in the first image Img_1 in FIG. 1. After that, the transform function for the second align point AP_25 and the first align point AP_15 is applied to transform the second ridge points in a predetermined range (e.g. PR in FIG. 6) of the second align point AP_25 to second transformed ridge points. Next, abandoning the transform function for the second align point AP_25 and the first align point AP_15 if a matching level between the second transformed ridge points and the first ridge points in the predetermined range of the first align point AP_15 is lower than a predetermined level. Partial or all of the transform functions can be checked following this way. After that, it is supposed that M best transform functions are selected from retained transform functions, as illustrated in the step 311.

In one embodiment, after the steps 309 and 311, the step 313 is performed to the transform functions calculated from the step 311. The step 313 applies similar steps of the step 309. However, several predetermined ranges (e.g. PR in FIG. 6) of test align points are selected in the step 313. That is, more than one predetermined ranges of test align points from the second ridge points are selected (ex. second align points AP_25, AP_26, AP_27 in FIG. 6). Please note, the test align point selected in the step 309 and the test align points selected in the step 313 can be the same, but can be different as well.

Next, a transform function T2 among the transform functions acquired in the step 311 is applied to transform the second ridge points in the selected predetermined ranges to second transformed ridge points. Afterwards, abandoning the transform function T2 if a matching level between the second transformed ridge points and the first ridge points in the selected predetermined ranges is lower than a predetermined level. After that, it is supposed that N best transform functions are selected from retained transform functions, as illustrated in the step 315.

Briefly, M retaining transform functions are retained in the steps 309 and 311. After that, a plurality of test align points are selected in the step 313 to check local structures thereof via applying at least one transform function among the M retaining transform functions.

In the step 317, the N transform functions are applied to every second ridge points to acquire a matching level. Also, in one embodiment, in the step 319, a best transform function is selected form the N transform functions, depending on the matching level, to transform the second image Img_2 to a transformed second image.

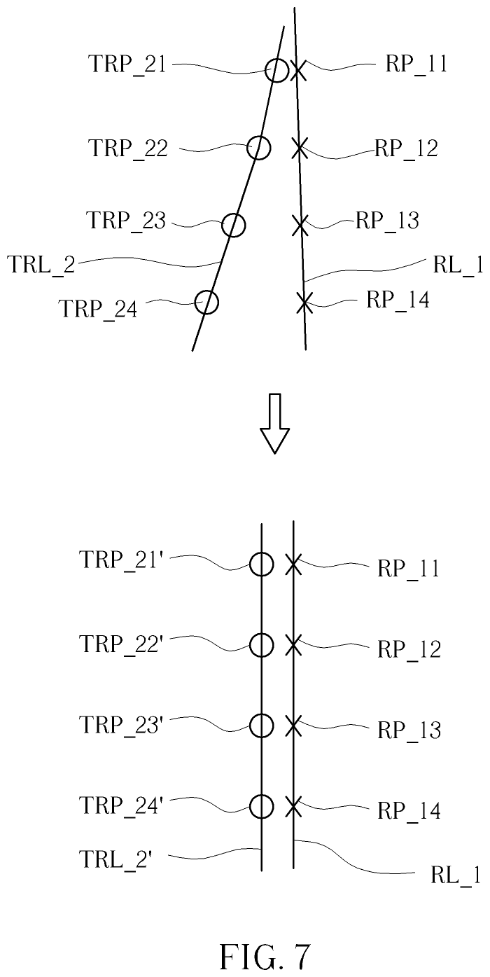

In the step 321, the transform function generated in the step 319 is further refined. As illustrated in FIG. 7, the transformed ridge line TRL_2 is generated from transforming a ridge line of the second image via applying the transform function generated in the step 319. The matching level of the second transformed ridge point TRP_21 and the first ridge point RP_11 is high (i.e. few errors between the second transformed ridge point TRP_21 and the first ridge point RP_11), but the matching levels of the second transformed ridge points TRP_22, TRP_23 and TRP_24, and the first ridge point RP_12, RP_13 and RP_14 are low (i.e. more errors between the second transformed ridge point TRP_21 and the first ridge point RP_11). Accordingly, the average matching level for the transformed ridge line TRL_2 and the first ridge line RL_1 is low.

Therefore, the transform functions for the second transformed ridge points TRP_21, TRP_22, TRP_23 and TRP_24 are averaged, to generate a refined transform function. Thereafter, a transformed ridge line TRL_2′ is generated from transforming a ridge line of the second image via applying the refined transform function to the ridge line of the second image (i.e. applying the refined transform function to modify the second transformed image). For the transformed ridge line TRL_2′, The matching level of the second transformed ridge point TRP_21′ and the first ridge point RP_11 becomes lower, but the matching levels of the second transformed ridge points TRP_22′, TRP_23′ and TRP_24′, and the first ridge point RP_12, RP_13 and RP_14 increase. Accordingly, the average matching level for the transformed ridge line TRL_2′ and the first ridge line RL_1 is higher than the average matching level for the transformed ridge line TRL_2 and the first ridge line RL_1. The steps for refining the transform function can be iteratively refined until a best transform function is acquired. Please note, such iteratively refine operation can be applied to the whole second image.

In view of above-mentioned embodiments, the fingerprint identification system provided by the present invention can be summarized as below: A fingerprint identification system, comprising: an image acquiring device (e.g. 101 in FIG. 1), configured to acquire at least one second image; and a processing circuit (e.g. 103 in FIG. 1). The processing circuit is configured to perform following steps: (a) selecting a plurality of first align points from first ridge points of a first image, and selecting a plurality of second align points from second ridge points of the second image (e.g. steps 303_a, 303_b in FIG. 3); (b) pairing at least one of the second align points to at least one first paired align point among the first align points (e.g. step 305 in FIG. 3); (c) calculating at least one transform function based on the second align point and the first paired align point (e.g. at least one of steps 307-323 in FIG. 3); and (d) transforming the second image to a second transformed image according to the transform function, and determining if the second image matches any part of the first image according to the second transformed image and at least part of the first image. A fingerprint identification can be easily acquired based on above-mentioned descriptions, thus details thereof are omitted for brevity here.

Based upon above-mentioned embodiments, only partial of the second image is compared with the first image, thus the calculation amount for identifying fingerprint can be greatly reduced and the speed of identifying fingerprint raises up.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fingerprint identification system, comprising:
an image acquiring device, configured to acquire at least one second image; and
a processing circuit, configured to perform following steps:
(a) selecting a plurality of first align points from first ridge points of a first image, and selecting a plurality of second align points from second ridge points of the second image;
(b) pairing at least one of the second align points to at least one first paired align point among the first align points;
(c) calculating at least one transform function based on the second align point and the first paired align point; and
(d) transforming the second image to a second transformed image according to the transform function, and determining if the second image matches any part of the first image according to the second transformed image and at least part of the first image.

2. The fingerprint identification system of claim 1, wherein a size of the first image is larger than a size of the second image.

3. The fingerprint identification system of claim 1, wherein the step (a) downsamples first ridge points to acquire the first align points or downsamples the second ridge points to acquire the second align points.

4. The fingerprint identification system of claim 1, wherein the processing circuit is further configured to perform:
abandoning the transform function or not calculating the transform function for the second align point and the first paired align point, if a number for the second ridge points in a predetermined region of the second align point or a number for the first ridge points in the predetermined region of the first paired align point is smaller than a predetermined number.

5. The fingerprint identification system of claim 1, wherein the processing circuit is further configured to perform:
abandoning the transform function or not calculating the transform function for the second align point and the first paired align point, if a difference between a number for the second ridge points in a predetermined region of the second align point and a number for the first ridge points in the predetermined region of the first paired align point is larger than a predetermined number.

6. The fingerprint identification system of claim 1, wherein the processing circuit is further configured to perform:
selecting at least one check point from the second ridge points;
applying the transform function to transform the check point to a transformed check point;
comparing the transformed check point to the first ridge points;
abandoning the transform function if matching levels between an angle of the transformed check point and angles of the first ridge points are smaller than a predetermined level.

7. The fingerprint identification system of claim 1, wherein the processing circuit is further configured to perform:
(e) selecting a first test align point from the second align points;
(f) applying the transform function for the first test align point and the first paired align point corresponding to the first test align point to transform the second ridge points in a predetermined range of the first test align point to second transformed ridge points; and
(g) abandoning the transform function for the first test align point if a matching level between the second transformed ridge points and the first ridge points in the predetermined range of the first paired align point corresponding to the first test align point is lower than a first predetermined level.

8. The fingerprint identification system of claim 7, wherein the step (g) retains at least one retaining transform function among the transform function calculated in the step (c);
wherein the processing circuit is further configured to perform:
selecting a plurality of second test align points from the second align points;
applying a transform function among the retaining transform function to transform the second ridge points in a predetermined range for each of the second test align points to second transformed ridge points; and
abandoning the transform function among the retaining transform function if a matching level between the second transformed ridge points and the first ridge points in the predetermined range of a first paired align point corresponding to the second test align point is lower than a second predetermined level.

9. The fingerprint identification system of claim 1, wherein the processing circuit is further configured to perform:
calculating a refined transform function based on errors between the second transformed image and the first image;
applying the refined transform function to modify the second transformed image; and
determining if the second image matches any part of the first image according to the second transformed image.

10. A fingerprint identification method, applied to a finger print identification system comprising an image acquiring device and a processing circuit, comprising
acquiring at least one second image via the image acquiring device;
performing following steps via the processing circuit:
(a) selecting a plurality of first align points from first ridge points of a first image, and selecting a plurality of second align points from second ridge points of the second image;
(b) pairing at least one of the second align points to at least one first paired align point among the first align points;
(c) calculating at least one transform function based on the second align point and the first paired align point; and
(d) transforming the second image to a second transformed image according to the transform function, and determining if the second image matches any part of the first image according to the second transformed image and at least part of the first image.

11. The fingerprint identification method of claim 10, wherein a size of the first image is larger than a size of the second image.

12. The fingerprint identification method of claim 10, wherein the step (a) downsamples first ridge points to acquire the first align points or downsamples the second ridge points to acquire the second align points.

13. The fingerprint identification method of claim 10, further comprising:
applying the processing circuit to abandon the transform function or not to calculate the transform function for the second align point and the first paired align point, if a number for the second ridge points in a predetermined region of the second align point or a number for the first ridge points in the predetermined region of the first paired align point is smaller than a predetermined number.

14. The fingerprint identification method of claim 10, further comprising:
applying the processing circuit to abandon the transform function or not to calculate the transform function for the second align point and the first paired align point, if a difference between a number for the second ridge points in a predetermined region of the second align point and a number for the first ridge points in the predetermined region of the first paired align point is larger than a predetermined number.

15. The fingerprint identification method of claim 10, further comprising applying the processing circuit to perform following steps
selecting at least one check point from the second ridge points;
applying the transform function to transform the check point to a transformed check point;
comparing the transformed check point to the first ridge points;
abandoning the transform function if matching levels between an angle of the transformed check point and angles of the first ridge points are smaller than a predetermined level.

16. The fingerprint identification method of claim 10, further comprising applying the processing circuit to perform following steps:
(e) selecting a first test align point from the second align points;
(f) applying the transform function for the first test align point and the first paired align point corresponding to the first test align point to transform the second ridge points in a predetermined range of the first test align point to second transformed ridge points; and
(g) abandoning the transform function for the first test align point if a matching level between the second transformed ridge points and the first ridge points in the predetermined range of the first paired align point corresponding to the first test align point is lower than a first predetermined level.

17. The fingerprint identification method of claim 16, wherein the step (g) retains at least one retaining transform function among the transform function calculated in the step (c);
wherein the processing circuit is further applied to perform:
selecting a plurality of second test align points from the second align points;
applying a transform function among the retaining transform function to transform the second ridge points in a predetermined range for each of the second test align points to second transformed ridge points; and
abandoning the transform function among the retaining transform function if a matching level between the second transformed ridge points and the first ridge points in the predetermined range of a first paired align point corresponding to the second test align point is lower than a second predetermined level.

18. The fingerprint identification method of claim 10, further comprising applying the processing circuit to perform following steps:
calculating a refined transform function based on errors between the second transformed image and the first image;
applying the refined transform function to modify the second transformed image; and
determining if the second image matches any part of the first image according to the second transformed image.
